(19) United States
(12) Patent Application Publication
(10) Pub. No.: US 2023/0209697 A1
(43) Pub. Date: Jun. 29, 2023

(54) 3 MEV TO 90 MEV PROTON CYCLOTRON FOR NEUTRON BEAM PRODUCTION

(71) Applicant: Best Theratronics, Ltd., Kanata (CA)

(72) Inventors: Richard Johnson, Vancouver (CA); Karim Butalag, Brindisi (IT); Krishnan Suthanthiran, Lorton, VA (US)

(21) Appl. No.: 17/997,589

(22) PCT Filed: Apr. 28, 2021
(86) PCT No.: PCT/CA2021/050583

§ 371 Date: Oct. 31, 2022

Related U.S. Application Data
(60) Provisional application No. 63/019,187, filed on May 1, 2020.

(51) Int. Cl. H05H 13/00; H05H 3/06; H05H 6/00

(52) U.S. Cl. CPC H05H 13/005; H05H 3/06; H05H 6/00

(57) ABSTRACT

Systems and methods for use of a proton beam or a negative hydrogen ion beam cyclotron for production of a flux of a neutron beam and its use in investigation of material analysis is provided. The methods, apparatuses and uses include positioning a target material for irradiation on a sample holder, focusing a proton ion beam or a negative hydrogen ion beam from the cyclotron to the target material; irradiating the target material to induce a proton-neutron reaction thereby producing a flux of a neutron beam; transmitting the flux of the neutron beam through a neutron spectrum modulator, focusing the flux of the neutron beam to a sample material thereby producing a radiation emission; and detecting the radiation emission using a detector.

### FIELD OF THE INVENTION

The present invention relates generally to cyclotrons and particularly to a compact proton cyclotron or an H⁻ cyclotron having energies in a range of from and including 3 MeV to 90 MeV for producing a flux of a neutron beam source for materials analysis in various industrial applications.

### BACKGROUND

Cyclotrons have been known for many years. A cyclotron is one type of particle accelerators in which charged particles are accelerated through a substantially spiral path using the forces of electrical potential and magnetic fields. The first cyclotron was invented by Ernest O. Lawrence in 1929-1930 at the University of California, Berkeley, for which he was awarded the Nobel Prize in Physics in 1939.

A cyclotron accelerates a charged particle beam using a high frequency alternating voltage which is applied between two hollow “D”-shaped sheet metal electrodes called “dees” inside a vacuum chamber. The path of the accelerated particle is then bent by a magnetic field into a spiral path (due to the Lorentz force perpendicular to their direction of motion), which tends to cause the particle to be directed back across the gap. By alternately changing the polarity of the electrodes by means of a radio-frequency generating system, the particles are accelerated with each crossing of the gap, thereby increasing the radius of the spiral path of the accelerated particles. When the accelerated particles reach the rim of the chamber a small voltage on a metal plate deflects the beam and hits a target located at the exit point at the rim of the chamber.

For example, U.S. Pat. No. 5,139,731 to Hendry, incorporated herein by reference in its entirety, discloses a negative ion (H⁻) cyclotron caused by the gas stripping of the H⁻ ions in the acceleration region. The system comprises a negative hydrogen ion cyclotron which defines a cyclotron volume, a negative hydrogen ion (H⁻) source which defines a H⁻ ion source volume, and a vacuum system and a radio-frequency system for accelerating the ions within the cyclotron volume, the cyclotron volume having an acceleration plane in which the hydrogen ions are accelerated and deflected in a spiral path at an ion orbital frequency.

For example, U.S. Pat. No. 7,554,275 to Amaldi et al., incorporated herein by reference in its entirety, discloses a proton accelerator cyclotron. The cyclotron comprises a target positoned either internally or externally to the cyclotron, a medium energy beam transport magnetic channel, a radiofrequency linear accelerator, a high energy beam transport channel towards an area dedicated to the irradiation of tumors with proton beams, as well as a modular system for supplying radio frequency power capable of feeding, independently two or more accelerating modules of the linac. Further, Amaldi discloses an integrated computerized system that controls the complex of accelerators, either in alternation or simultaneously.

Further, U.S. Pat. No. 4,112,306 to Craig S. Nunan, incorporated herein by reference in its entirety, discloses a neutron irradiation therapy cyclotron for treating patients with a beam of high energy neutrons. The cyclotron accelerates a beam of charge particles, such as protons, to relatively high energy, such as 30 MeV, to bombard a target formed of first and second materials, wherein the first constituent material of the target is selected from the group consisting of beryllium, lithium and carbon-13 and the second group consisting of carbon, graphite and gold.

For example, U.S. Pat. No. 4,139,777 to William Rautenbach, incorporated herein by reference, discloses a cyclotron suitable for use in neutron therapy, wherein the deuteron energy is about 20 to 30 MeV, and conveniently, about 35 MeV. In the case of a proton cyclotron, the proton is accelerated at an energy in the range of about 15 to 100 MeV, and conveniently at least about 35 MeV.

Additionally, for example, York et al., “Neutron Beam From the UCLA Spiral-Ridge Cyclotron,” Proceedings of the International Conference on Sector-Focused Cyclotrons and Meson Factories, Geneva, Apr. 23-26, 1963, incorporated herein by reference in its entirety, discloses the production of an intense beam of neutrons from the UCLA Sprial-Ridge Cyclotron by bombarding the deuterium contained in heavy water, D₂O, with the proton beam of a cyclotron having a beam current of 100 micro-Amperes and having an energy of 4 MeV to 8 MeV.

For example, Mitsumoto et al., “Cyclotron-based neutron source for BNCT”, AIP Conference Proceedings, 2013, incorporated herein by reference in its entirety, discloses a cyclotron-based neutron source for Boron Neutron Capture Therapy (BNCT). It was installed at KURRI in Osaka prefecture. The neutron source consists of a proton cyclotron named HM-30, a beam transport system and an irradiation and treatment system. In the cyclotron, H⁻ ions are accelerated and extracted as 30 MeV proton beams of 1 mA. The proton beams are transported to the neutron production target made by a beryllium plate.

For example, G. Demortier and F. Bodart “Complementarity of PIXE and PIGE for the characterization of gold items of ancient jewelry”, Journal of Radioanalytical Chemistry, Vol 69, No. 1-2 (1982) 239-257, incorporated herein by reference in its entirety, disclose the use of a 3 MeV proton accelerator to perform both Proton Induced X-ray Emission spectroscopy and Proton Induced Gamma ray Emission spectroscopy, in order to have a simultaneous composition of both low and mid Z elements in the samples.

Also for example, M. Budnar et al. “In-air Pixe set-up for automatic analysis of historical document inks” Nuclear Instrument and Methods in Physics Research B 219 (2004) 41-47, incorporated herein by reference in its entirety, disclose the use of PIXE in air in order to analyze samples not suitable for the vacuum (as old manuscript). This article also provides a discussion about the importance of having a reliable sample holding system, which is also able to allow the fast change of the samples.

While hydrogen and deuteron cyclotrons have been used to produce neutrons, there is very little is known about the use of a 3 MeV to 90 MeV cyclotron for neutron beam production including radioisotope production and neutron radiology. Accordingly, there is a need for a compact low energy proton cyclotron or an H⁻ cyclotron having a beam energy in a range of from and including 3 MeV to 90 MeV for producing a flux of a neutron beam source for subsequent industrial applications.

Thus, apparatuses and methods of using a proton cyclotron or an H⁻ cyclotron to produce a flux of intense neutron beams addressing the aforementioned needs and problems is desired.

### SUMMARY OF INVENTION

Embodiments include apparatuses, systems and methods related to the use of a proton cyclotron or an H⁻ cyclotron for production of a flux of a neutron beam applicable in various industrial and medical settings. The apparatus, methods and uses include positioning a target material for irradiation on a sample holder, focusing a proton or an H⁻ ion beam from the cyclotron to the target material, irradiating the target material to induce a proton-neutron reaction thereby producing a flux of a neutron beam, transmitting the flux of the neutron beam through a neutron spectrum modulator, transmitting the flux of neutron beam to a sample thereby producing a radiation emission, and detecting the radiation emission using a detector, wherein the flux of the neutron beam is produced by the cyclotron having an energy in a range of from and including 3 MeV to 90 MeV and having a beam current equal to or greater than 400 micro Amperes, or desirably a beam current in a range of from and including 400 micro Amperes to 1.5 milli Amperes. Embodiments of the methods can further include analyzing the radiation emission from the sample material using a neutron detector, for example.

The apparatus and methods related to the use of a proton cyclotron or an cyclotron for neutron beam production can further include a cyclotron configured to provide a particle beam line of a proton ion beam or a negative hydrogen ion beam to a target material, wherein the particle beam line produced by the cyclotron has an energy in a range of from and including 3 MeV to 90 MeV, a target holder to hold a target material for producing a flux of neutrons, a neutron spectrum modulator configured to modulate the flux of neutrons, a sample for irradiation with the flux of neutrons, and a detector configured to detect a radiation emission from the sample. The beam current of the proton particle beam is desirably greater than 400 micro Amperes, desirably in a range from and including 400 micro Amperes to 1.5 milli Amperes. The detector can be a neutron detector and may be placed at a geometry and at an angle between 0° to 180° relative to the flux of neutron particle beam line.

These and other features of the present invention will become readily apparent upon further review of the following specification and drawings.

### DESCRIPTION OF THE DRAWINGS

FIG. 1 is a schematic drawing illustrating an overview of an embodiment of a 3 MeV to 90 MeV proton cyclotron or an H⁻ cyclotron system according to the present invention.

Unless otherwise indicated, similar reference characters denote corresponding features consistently throughout the attached drawing.

### DETAILED DESCRIPTION

The present disclosure relates to a 3 MeV to 90 MeV proton or H⁻ cyclotron having a current desirably greater than 400 micro Amperes, desirably in a range from and including 400 micro Amperes to 1.5 milli Amperes, configured to generate a particle beam of a proton ion beam or hydrogen ion beam, the hydrogen ion beam being desirably being a negative hydrogen ion beam (H⁻), to a target sample material for production of a flux of a neutron beam that in turn can be used in characterizing the atomic compositions of materials or to induce fragmentation of a heavy nucleus, for example.

As described herein, embodiments of a comprehensive cyclotron system for neutron beam production includes an easy to operate a proton ion beam or a hydrogen ion beam cyclotron, a negative ion or proton or H⁻ cyclotron, a beam delivery system, a production target, a neutron spectrum modulator, a sample target and a detector system. As to negative hydrogen ion cyclotrons, U.S. Pat. No. 5,139,731 to Hendry, incorporated by reference herein in its entirety, discloses a negative hydrogen ion (proton) cyclotron wherein the H⁻ is produced by H₂ gas stripping of ions, and U.S. Pat. No. 7,554,275 to Amaldi et al., incorporated by reference herein in its entirety, disclose a proton accelerator cyclotron. As to charged particle accelerator systems, U.S. Pat. No. 8,659,243 to Morita et al., incorporated herein by reference in its entirety, discloses an accelerating tube for the cyclotron. As to a proton cyclotron for neutron beam production, U.S. Pat. No. 4,139,777 to Rautenbach, incorporated by reference herein in its entirety, discloses a cyclotron suitable for producing neutrons, and U.S. Pat. No. 4,112,306 to Craig S. Nunan, incorporated herein by reference in its entirety, discloses a neutron irradiation therapy 30 MeV cyclotron for treating patients with a beam of high energy neutrons. All these patents are incorporated herein by reference in their entirety and, for example, include features that can be adapted for use in the methods and apparatuses of the various embodiments described herein using the guidance of the instant disclosure.

Embodiments of methods for use of a proton cyclotron or an H⁻ cyclotron for materials analysis, medical and other industrial applications include positioning a target material for irradiation on a sample holder, focusing a proton ion beam or an H⁻ ion beam from the cyclotron to the target material; irradiating the target material to induce a proton-neutron reaction thereby producing a flux of a neutron beam, transmitting the flux of the neutron beam through a neutron spectrum modulator, focusing the flux of the neutron beam to a sample thereby producing a radiation emission; and detecting the radiation emission using a detector, wherein the flux of neutron beam is produced by the cyclotron having an energy in a range of from and including 3 MeV to 90 MeV and having a beam current greater than 400 micro Amperes, desirably in a range of from and including 400 micro Amperes to 1.5 milli Amperes. The methods can further include analyzing the radiation emission from the sample material using a neutron detector, for example. Typically, the target material can include beryllium or lithium for the production of a flux of neutrons, although other suitable target materials can be used and should not be construed in a limiting sense.

Embodiments of apparatuses for use of a proton cyclotron or an H⁻ cyclotron for neutron beam production can further include a cyclotron configured to provide a particle beam line of hydrogen ions, a proton ion beam or hydrogen ion beam transmitted to a target material, wherein the particle beam line produced by the cyclotron has an energy in a range of from and including 3 MeV to 90 MeV and has a bean current equal to or greater than 400 micro Amperes, and desirably has a beam current in a range of from and including 400 micro Amperes to 1.5 milli Amperes, a target holder to hold a target material for producing a flux of neutrons, a neutron spectrum modulator configured to modulate the flux of the neutrons, a sample for irradiation with the particle beam line from the cyclotron to induce a proton-neutron reaction thereby producing the flux of neutrons, and a detector configured to detect a radiation emission from the sample. The beam current of the particle beam, such as a proton ion beam or a hydrogen ion beam, such as a proton particle beam, is equal to or greater than 400 micro Amperes but the beam current can be any of suitable ranges or amounts of beam current, as can depend on the use or application, and should not be construed in a limiting sense. Also, the beam current of the proton beam or the H⁻ particle beam desirably can be in the range of from and including 400 micro Amperes to 1.5 milli Amperes, for example. The detector can include a neutron detector, or other suitable reaction product detector, that is well known to those of ordinary skill in the art. The target material can include beryllium or lithium, or other suitable material, as can depend on the use or application and should not be construed in a limiting sense. Desirably, the detector may be placed at an angle between 0° to 180° relative to the neutron particle beam line. The type of detector used depends on the desired application and, therefore, should not be construed in a limiting sense.

In an embodiment, a neutron detector can be used for detecting the neutron component in the detection system, such as for example in neutron radiography, medical applications or radio safety applications or other suitable applications, for example, and should not be construed in a limiting sense.

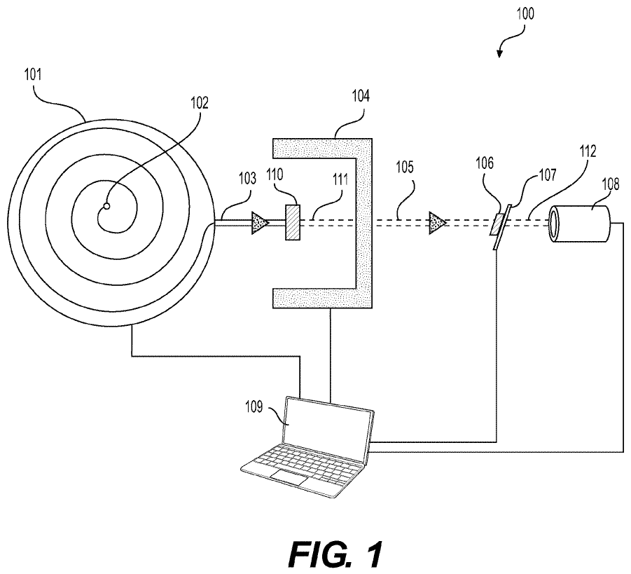

Referring now to the drawings in greater detail, FIG. 1 illustrates an exemplary cyclotron system 100, such as a proton or an H⁻ cyclotron system 100, such as for production of a flux of neutrons applicable in industrial settings. The cyclotron system 100 has an energy in a range of from and including 3 MeV to 90 MeV, and desirably has a beam current of greater than or equal to 400 micro Amperes. Desirably, the beam current range is in a range of from and including 400 micro Amperes to 1.5 milli Amperes, for example. The cyclotron system 100, such as a proton or an H⁻ cyclotron system 100, within this energy range of from 3 MeV to 90 MeV, can, depending on the use or application, also be provided to have a range of energy from and including 3 MeV to 70 MeV, and, possibly, for other applications, have a range of energy from and including 3 MeV to 14 MeV, for example, and the range of energy should not be construed in a limiting sense. The beam current, as can be a high beam current, can also desirably be in a range of from and including 0.5 mA to 1.5 mA, for example, but other suitable ranges of beam current can be used, as can depend on the use of application and should not be construed in a limiting sense. Suitable target materials can include, but are not limited to, lithium, beryllium, or tungsten, for example, or other suitable materials as can depend on the use or application, and should not be construed in a limiting sense. As further illustrated in FIG. 1, the cyclotron system 100 includes a compact cyclotron 101, which desirably is a proton or a H⁻ compact cyclotron, and which also desirably has or is associated with an ionizing source 102 that can be a hydrogen gas, or other suitable ionizing source. The protons or negative hydrogen ions are extracted from the compact cyclotron 101, such as a negative ion proton cyclotron 101 having a source 102, such as a hydrogen ion source 102, and are directed through a beam line 103, such as a tube beam line 103, to a production target material 110. The compact cyclotron 101 is associated with the beam line 103, such as a short extract beam line 103, to direct the proton beam or the negative hydrogen ion beam to the production target material 110. These protons or the H⁻ ions produce secondary beams of neutrons 111 through a production target with nuclear reactions with the target material 110 that can include beryllium, lithium or tungsten, for example, or other suitable target material. The target material 110 typically includes materials having a relatively high neutron yield upon bombardment with the proton beam 103, for example. The neutrons 111 produced are then passed through a neutron spectrum modulator 104 and a modulated neutron beam 105 is transmitted to and used in irradiation of a sample 106 that is placed on a sample holder 107. The geometry of the sample holder 107 can be changed vertically or horizontally, or in other suitable configurations, depending upon the desired analysis configuration requirement for the neutrons or photons, for example.

Without wishing to be bound by theory, it is believed that the irradiation protons or the negative hydrogen ions interact with the neutrons of the target via the (p, x n) reaction to produce a flux of neutrons. The secondary flux of the neutron beam 105 when directed to the sample 106 induce a reaction with the atomic materials of the sample 106 causing them to emit radiation 112, such as Electromagnetic radiation in the X-ray or γ-ray region or outgoing nucleons. Thus, the electromagnetic radiation 112, such as X-ray and γ-ray emission of radiation 112, is detected either in the forward or backward direction using a X-ray or a gamma ray detector 108 by changing the geometry and alignment with respect to the beam line of the emitted radiation 112. A similar process occurs for detecting outgoing nucleons using their respective detectors. The X-ray and γ-ray and outgoing nucleons characteristics are set by the materials that interact with the irradiation neutrons on the sample of interest, such as the sample 106. The detector 108 can also include, but is not limited to, a neutron detector to detect the neutrons, such as in neutron radiology, and the detector 108 can be any of various detectors, as can depend on the use or application and the reaction products to be detected, and should not be construed in a limiting sense.

In some embodiments of the apparatuses and methods, for example, one may use a photon detector if the gamma detection caused by neutron activation such as in (n,γ) reactions is of interest. Also, in various embodiments, the detection technique can include Particle-induced X-ray emission (PIXE). PIXE is a technique used in analyzing the elemental make-up of a material or sample. Without being bound by theory, it is believed that when a material is exposed to an ion beam, atomic interactions occur that give off electromagnetic (EM) radiation of wavelengths in the X-ray part of the electromagnetic spectrum specific to an element. Thus, PIXE is a powerful yet non-destructive elemental analysis technique to analyze the materials according to the present invention. Exemplary PIXE technology as can be utilized, as modified by the guidance of the instant disclosure, can include, for example, the research article to Keizo Ishii, “PIXE and Its Applications to Elemental Analysis”, Quantum Beam Sic., 2019, 3, 1-14, incorporated herein by reference in its entirety, which discloses particle induced X-ray emission imaging apparatus, a silicon detector and a method for analyzing the characteristic X-rays emitted by the elements, such as sodium and uranium contained in a sample. Due to the high signal to background ratio, PIXE is a nondestructive technique and very sensitive, and can be used for a wide range of measured elements, with detection limits close to 1 ppm, for example.

In embodiments of the apparatuses and methods, for example, the detection technique can also include Particle-induced gamma-ray emission (PIGE). PIGE is a technique used in several fields to be able to determine the elemental composition of a given sample. A high energy ion could go closer to a nucleus if its energy is higher than what is called a coulomb barrier of the nuclei. This can happen easier for low Z atoms (because they have less protons in the nucleus). When an ion is able to go close to a nucleus, it is able excite the nucleus which may return in a stable state by emitting photons in the gamma spectrum. PIGE is usually used together with PIXE because of their intrinsic complementarity (as reported in G. Demortier and F. Bodart “Complementarity of PIXE and PIGE for the characterization of gold items of ancient jewelry”, Journal of Radioanalytical Chemistry, Vol 69, No. 1-2 (1982) 239-257), incorporated herein by reference in its entirety.

Exemplary technology as can be utilized, as modified by the guidance of the instant disclosure, as can include, for example, U.S. Pat. No. 7,888,891 to Lida et al., incorporated herein by reference in its entirety, which discloses particle beam accelerators (cyclotron). Also, such exemplary technology can include, for example, U.S. Pat. No. 4,112,306 to Craig S. Nunan, incorporated herein by reference in its entirety, which discloses a neutron irradiation therapy cyclotron for treating patients with a beam of high energy neutrons. The cyclotron accelerates a beam of charge particles, such as protons, to relatively high energy, such as of 30 MeV, to bombard a target formed of first and second materials, wherein the first constituent material of the target is selected from the group consisting of beryllium, lithium and carbon-131. Other charged particle accelerator technologies can include, for example, U.S. Pat. No. 8,779,939 to Sasai et al., incorporated herein by reference in its entirety, which discloses a charged particle beam irradiation system and a neutron beam irradiation system.

Continuing with reference to FIG. 1, a computer controller system 109 is used to control the proton beam or the negative hydrogen ion beam and the beam intensity to accurately and precisely deliver protons or hydrogen ions to the production target material 110. The computer controller system 109 desirably is a single control system for controlling the plurality of the components of the cyclotron system 100, such as the compact cyclotron 101 to provide the proton or negative hydrogen ion beam of the requisite intensity, and the detector 108 to analyze the neutron, X-ray and γ-ray emission spectrum, for example. Further, display elements of a display system in the computer controller system 109 are desirably controlled via a main controller in the computer controller system 109. Displays, such as display screens, are typically provided to one or more operators. In an embodiment, for example, the computer controller system 109 accurately calculates the delivery of the proton beam or the negative hydrogen ion beam 103, or other suitable radiation source, that are delivered in an optimal manner to the target material 110. In embodiments, the cyclotron system 100, such as including the compact cyclotron 101, such as a proton or negative hydrogen ion particle beam compact cyclotron 101, or other suitable radiation source system, including the detector 108, can be automated or semi-automated, for example.

The computer controller system 109 controls operations and the above-described components of the cyclotron system 100, such as including the compact cyclotron 101, such as a proton or negative hydrogen ion particle beam compact cyclotron 101, with input from the control panel, such as the keys on the computer controller system 109. It should be understood that the computer controller system 109 may represent, for example, a stand-alone computer, computer terminal, portable computing device, networked computer or computer terminal, or networked portable device. Data, programs or instructions for control and operation of the cyclotron system 100 for the generation and delivery of the proton or negative hydrogen ion particle beam by and from the cyclotron system 100 and for the detection of the radiation emission by the detector 108 may be entered into the computer controller system 109 by the user via any suitable type of user interface, such as the control panel or computer keys, and may be stored in a computer readable memory in or associated with the computer controller system 109, which may be any suitable type of computer readable and programmable memory. Calculations and control of the radiation generation, delivery and detection in the cyclotron system 100, such as the generation of the proton or the negative hydrogen ion particle beam 103, for example, for delivery of the radiation to the target material 110 are performed by a controller/processor of or associated with the computer controller system 109, which may be any suitable type of computer processor, and may be displayed to the user on a display of or associated with the computer controller system 109, which may be any suitable type of computer display, such as a liquid crystal display (LCD) or a light emitting diode (LED) display, for example. Though not shown, another display can be connected to computer controller system 109 to provide or show desired information related to the beam generation, delivery and detection processes, and the like, for example.

The controller/processor in or associated with the computer controller system 109 may be associated with, or incorporated into, or be any suitable type of computing device, as, for example, a personal computer or a programmable logic controller (PLC) or an application specific integrated circuit (ASIC). The display of the computer controller system 109, the controller/processor of or associated with the computer controller system 109, the memory in or associated with the computer controller system 109, and any associated computer readable media are in communication with one another by any suitable type of data bus or by wireless communication, as is well known in the art. In this manner, the computer controller system 109 is in communication with the cyclotron system 100, for control of the cyclotron system 100 for generation and delivery of the proton or negative hydrogen ion beam and detection of the radiation emission from the sample 106, for example.

Examples of computer readable media in or associated with the computer controller system 109 include a magnetic recording apparatus, non-transitory computer readable storage memory, an optical disk, a magneto-optical disk, and/or a semiconductor memory (for example, RAM, ROM, etc.). Examples of magnetic recording apparatus that may be used in addition to the memory in or associated with the computer controller system 109, or in place of such memory, include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.

Advantageously, the systems that deliver the protons or negative hydrogen ions (H⁻) to induce production of neutron beams are typically only operationally practical at these energies in a range of from and including 3 MeV to 90 MeV and the cyclotron is much more compact as compared to those described in the prior art. Additionally, the cyclotron apparatus of the present invention is cost effective for producing the flux of neutrons that in turn produce X-rays and γ-rays for conducting material analysis. The applications are intended for but not limited to radioisotope production, neutron activation analysis of materials, or neutron radiography, neutron cross section studies, medical applications by using fast neutrons or epithermal neutrons, radiation damage studies which are important for space missions, military applications and accelerator driven nuclear reactors or other suitable applications, and should not be construed in a limiting sense.

It is to be understood that the embodiments of the methods, apparatuses and systems taught and described in terms of a proton beam or a negative hydrogen ion (H⁻) beam for production of a flux of neutrons are not intended to be limited to that of a proton beam or a negative hydrogen ion (H⁻) beam and are illustrative of and are applicable to of any of various suitable charged particle beam systems, as can depend on the use or application, and should not be construed in a limiting sense.

It is to be understood that the present invention is not limited to the embodiments described above but encompasses any and all embodiments within the scope of the following claims.

We claim:

1. A method for using a cyclotron for producing a flux of neutron beams, comprising the steps of:
positioning a target material on a sample holder;
focusing a beam comprising a proton ion beam or a negative hydrogen ion beam from the cyclotron to the target material;
contacting the target material with the beam to induce a proton-neutron reaction thereby producing a flux of a neutron beam;
transmitting the flux of the neutron beam through a neutron spectrum modulator;
focusing the flux of the neutron beam to a sample; and
detecting neutrons or other reaction products emitted from the sample using a detector;
wherein the cyclotron has an energy in a range of from and including 3 MeV to 90 MeV and has a beam current greater 400 micro Amperes.

2. The method for using a cyclotron for producing a flux of neutron beams according to claim 1, wherein the beam current is in a range of from and including 400 micro Amperes to 1.5 Milli Amperes.

3. The method for using a cyclotron for producing a flux of neutron beams according to claim 1, wherein the target material is beryllium or lithium.

4. The method for using a cyclotron for producing a flux of neutron beams according to claim 1, wherein the detector is a neutron detector or other reaction product detector.

5. An apparatus for neutron beam production, comprising:
a cyclotron configured to provide a particle beam line of a proton ion beam or a negative hydrogen ion beam to contact a target material, wherein the proton ion beam or the negative hydrogen ion beam produced by the cyclotron has an energy in a range of from and including 3 MeV to 90 MeV;
a target holder configured to hold the target material, the proton ion beam or the negative hydrogen ion beam contacting the target material to produce a flux of neutrons;
a neutron spectrum modulator configured to modulate the flux of neutrons;
a sample holder configured to hold a sample material for irradiation with the flux of neutrons; and
a detector configured to detect neutrons or other reaction products from the sample material generated by the irradiation of the sample with the flux of neutrons.

6. The apparatus for neutron beam production according to claim 5, further comprising: a computer controller system configured to control the cyclotron to generate and deliver the proton ion beam or the negative hydrogen ion beam of the particle beam line for the irradiation of the target material.

7. The apparatus for neutron beam production according to claim 5, wherein the target material is beryllium or lithium or other target materials.

8. The apparatus for neutron beam production according to claim 5, wherein a beam current of the proton ion beam or the negative hydrogen ion beam is equal to or greater than 400 micro Amperes.

9. The apparatus for neutron beam production according to claim 5, wherein a beam current of the proton ion beam or the negative hydrogen ion beam is in a range of from and including 400 micro Amperes to 1.5 Milli Amperes.

10. The apparatus for neutron beam production according to claim 5, wherein the detector is a neutron detector or other reaction product detector.

11. The apparatus for neutron beam production according to claim 5, wherein the detector is placed at an angle between 0° to 180° relative to a neutron beam line generated by the irradiation of the sample material with the flux of neutrons.

12. The apparatus for neutron beam production according to claim 5, wherein the cyclotron has an energy in a range of from and including 3 MeV to 70 MeV.

13. The apparatus for neutron beam production according to claim 5, wherein the cyclotron has an energy in a range of from and including 3 MeV to 14 MeV.

14. The apparatus for neutron beam production according to claim 13, wherein the particle beam line comprises a high current proton beam.
